(19) United States
(12) Patent Application Publication
(10) Pub. No.: US 2026/0114440 A1
(43) Pub. Date: Apr. 30, 2026

(54) BREAKAWAY ATTACHMENT FOR HEAVY EQUIPMENT

(71) Applicant: H&H BROTHERS LLC, FORT WHITE, FL (US)

(72) Inventor: Nathanael M. HALL, Fort White, FL (US)

(21) Appl. No.: 18/927,074

(22) Filed: Oct. 25, 2024

(51) Int. Cl. A01M 7/00

(52) U.S. Cl. CPC A01M 7/0078

(57) ABSTRACT

A breakaway attachment for heavy equipment includes a stationary section having a first stationary end, a breakaway section having a coupling end, and a breakaway joint comprising a spring coupling to the first stationary end of the stationary section and the coupling end of the breakaway section. In some cases, the stationary section further includes a second stationary end, and the breakaway attachment further includes a second breakaway section having a second coupling end and a second breakaway joint comprising a second spring coupling to the second stationary end of the stationary section and the second coupling end of the second breakaway section.

### BACKGROUND

Breakaway attachments for heavy equipment (e.g., tractors and/or skid steers) are typically made so that when the attachment comes into contact with a stationary object (e.g., the ground, a pole, etc.) at least a portion of the attachment can move about a connection and/or joint in the attachment so that no damage is done to the attachment and/or object. Because these breakaway attachments are designed for (relatively) open fields, the movement is usually limited to upward (e.g., for ground contact) movement and even sometimes forward or backward movement (e.g., for contact with a pole), however, these breakaway attachments are not designed to provide downward movement.

Solar farms include rows and/or columns of solar panels attached to structure to position the solar panels to receive the maximum amount of sunlight. The panels are usually tightly spaced so that the maximum amount of energy can be harvested for the space the solar farm utilizes. With the proliferation of solar farms for energy, existing attachments (e.g., for herbicide applications and/or mowing) can cause damage to the attachments, the solar panels and/or the structure the solar panels are attached to by not providing the ability of the attachments to “breakaway” in an upward, downward, forward, and backward movement, which is needed due to the tight spacing of the solar panels and their structure.

### BRIEF SUMMARY

A breakaway attachment for heavy equipment is provided that allows for 360° (e.g., upward, downward, forward, and backward) compliant motion of the breakaway section of the breakaway attachment. Advantageously, by allowing for motion of the breakaway section of the breakaway attachment in all directions, the breakaway attachment can be used in areas (e.g., in and around solar fields) that normal attachments for heavy duty equipment (e.g., even attachments that allow for breakaways in some directions) are not capable of being used in without serious risk to the attachments themselves and/or object(s) in the area.

A breakaway attachment for heavy equipment includes a stationary section having a first stationary end, a breakaway section having a coupling end, and a breakaway joint comprising a spring coupling to the first stationary end of the stationary section and the coupling end of the breakaway section.

In some cases, the stationary section further includes a second stationary end, and the breakaway attachment further includes a second breakaway section having a second coupling end and a second breakaway joint comprising a second spring coupling to the second stationary end of the stationary section and the second coupling end of the second breakaway section.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 illustrates a breakaway attachment attached to a piece of heavy equipment.

FIGS. 2A and 2B illustrate views of a breakaway joint.

FIG. 3 illustrates a cross-sectional view of a breakaway joint.

FIGS. 4A-4D illustrate different positions of a breakaway joint.

FIGS. 5A-5C illustrate views of a breakaway joint having deflection support.

FIGS. 5D-5F illustrate cross-sectional views of a breakaway joint having deflection support.

FIGS. 5G-5I illustrate views of a breakaway joint in an upward position having deflection support.

FIGS. 5J-5L illustrate cross-sectional views of a breakaway joint in an upward position having deflection support.

FIGS. 5M-5O illustrate views of a breakaway joint in a backward position having deflection support.

### DETAILED DESCRIPTION

A breakaway attachment for heavy equipment is provided that allows for 360° (e.g., upward, downward, forward, and backward) compliant motion of the breakaway section of the breakaway attachment. Advantageously, by allowing for motion of the breakaway section of the breakaway attachment in all directions, the breakaway attachment can be used in areas (e.g., in and around solar fields) that normal attachments for heavy duty equipment (e.g., even attachments that allow for breakaways in some directions) are not capable of being used in without serious risk to the attachments themselves and/or object(s) in the area.

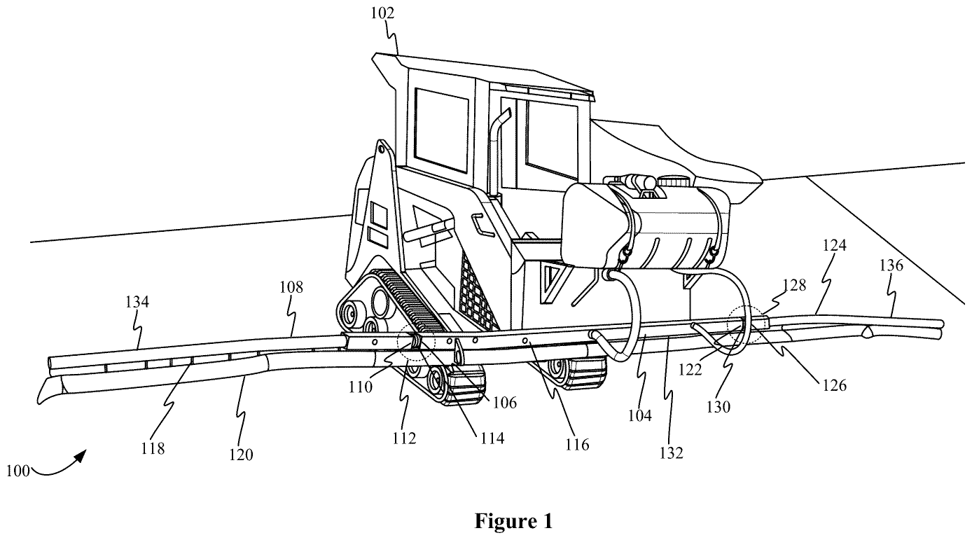

FIG. 1 illustrates a breakaway attachment attached to a piece of heavy equipment. Referring to FIG. 1, a breakaway attachment 100 for heavy equipment 102 includes a stationary section 104 having a first stationary end 106, a breakaway section 108 having a coupling end 110, and a breakaway joint 112 including a spring 114 coupling to the first stationary end 106 of the stationary section 104 and the coupling end 110 of the breakaway section 108.

In some cases, the breakaway attachment 100 includes a means for attaching 116 the breakaway attachment 100 to a piece of heavy equipment 102. In some cases, the heavy equipment 102 includes heavy machinery, light machinery, and/or compact machinery. The breakaway attachment 100 can be attached to the front or the back of the heavy equipment 102. In some cases, the means for attaching 116 the breakaway attachment 100 to the heavy equipment 102 includes a 3-point hitch, a drawbar, a trailer jack, a gooseneck hitch, a fifth-wheel hitch, a clamp-on hitch, a ball-mount hitch, and/or any other acceptable method of securing the breakaway attachment 100 to the heavy equipment 102 known to those skilled in the art. In some cases, the means for attaching 116 the breakaway attachment 100 to the heavy equipment 102 includes being welded to the frame of the heavy equipment 102, attached using nuts and bolts, attached using screws, and/or any other acceptable method of securing the breakaway attachment 100 to the heavy equipment 102 known to those skilled in the art.

In some cases, the breakaway attachment 100 includes a fluid conveyance device 118 coupled to the stationary section 104 and the breakaway section 108 for conveying a fluid. In some cases, the fluid conveyance device 118 is fluidically coupled to the heavy equipment 102. In some cases, the fluid conveyance device 118 includes plastic tubing. In some cases, the fluid conveyance device 118 includes piping. In some cases, the fluid conveyance device 118 includes hoses. In some cases, the fluid conveyance device 118 includes fittings such as valves, tees, and elbows. In some cases, the fluid conveyance device 118 conveys fluid through a hollow portion of the stationary section 104 and a hollow portion of the breakaway section 108. In some cases, the fluid conveyance device 118 is coupled to the exterior of the stationary section 104 and the breakaway section 108. In some cases, the fluid conveyance device 118 is coupled to the stationary section 104 and to the breakaway section 108 by means of zip ties, hooks, brackets, mechanical fasteners, and/or any means of coupling the fluid conveyance device 118 to the exterior of the stationary section 104 and the breakaway section 108 known to those skilled in the art.

In some cases, the breakaway attachment 100 includes a fluid applicator 120 coupled to the stationary section 104 and the breakaway section 108 and fluidically coupled to the fluid conveyance device 118 for applying the fluid to a surface. In some cases, the fluid applicator 120 is fluidically coupled to the fluid conveyance device 118 at more than one location. In some cases, the fluid applicator 120 includes nozzles. In some cases, the fluid applicator 120 includes a foam or other similar material that can be saturated with a liquid. In some cases, the fluid applicator 120 can apply the liquid to a surface via wicking. In some cases, the fluid applicator 120 includes a mesh fabric to couple the foam piece to the stationary section 104 and to the breakaway section 108. In some cases, the fluid applicator 120 is coupled to the stationary section 104 and to the breakaway section 108 by means of zip ties, hooks, brackets, and/or mechanical fasteners.

In some cases, the stationary section 104 further includes a second stationary end 122, and the breakaway attachment 100 further includes a second breakaway section 124 having a second coupling end 126 and a second breakaway joint 128 including a second spring 130 coupling to the second stationary end 122 of the stationary section 104 and the second coupling end 126 of the second breakaway section 124.

In some cases, breakaway attachment 100 for heavy equipment 102 includes a stationary section 104 having a first stationary end 106 and a second stationary end 122, a breakaway section 108 having a coupling end 110, and a breakaway joint 112 including a spring 114 coupling to the first stationary end 106 of the stationary section 104 and the coupling end 110 of the breakaway section 108, a second breakaway section 124 having a second coupling end 126 and a second breakaway joint 128 including a second spring 130 coupling to the second stationary end 122 of the stationary section 104 and the second coupling end 126 of the second breakaway section 124. In some cases, the fluid conveyance device 118 and the fluid applicator 120 are coupled to the stationary section 104, the first breakaway section 108, and the second breakaway section 124.

In some cases, the stationary section 104, the breakaway section 108, and/or the second breakaway section 124 are hollow. In some cases, the stationary section 104, the breakaway section 108, and/or the second breakaway section 124 are made of square metal tubing. In some cases, the stationary section 104, the breakaway section 108, and/or the second breakaway section 124 are made of round metal tubing and/or piping. In some cases, the stationary section 104, the breakaway section 108, and/or the second breakaway section 124 are made of round plastic tubing and/or piping.

In some cases, the stationary section 104 further includes a stationary section extension 132. In some cases, the first stationary end 106 and/or the second stationary end 122 are a different shape and/or material than the stationary section extension 132. In some cases, the first stationary end 106 and/or the second stationary end 122 are hollow while the stationary section extension 132 is solid. For example, the first stationary end 106 and/or the second stationary end 122 may be welded to the stationary section extension 132, attached using nuts and bolts, attached using screws, and/or any other acceptable method of securing the first stationary end 106 and/or the second stationary end 122 to the stationary section extension 132 known to those skilled in the art. In some cases, the first stationary end 106, the second stationary end 122, and the stationary section extension 132, or any combination thereof, may be monolithic. In some cases, an additional stationary section extension (not illustrated) can be added or subtracted from the stationary section 104 to allow the length of the stationary section 104 to be customizable for the application and/or use of the breakaway attachment 100.

In some cases, the breakaway section 108 further comprises a breakaway section extension 134. In some cases, the coupling end 110 is a different shape and/or material than the breakaway section extension 134. In some cases, the coupling end 110 is hollow while the breakaway section extension 134 is solid. For example, the coupling end 110 may be welded to the breakaway section extension 134, attached using nuts and bolts, attached using screws, and/or any other acceptable method of securing the coupling end 110 to the breakaway section extension 134 known to those skilled in the art. In some cases, the coupling end 110 and the breakaway section extension 134 may be monolithic. In some cases, an additional breakaway section extension (not illustrated) can be added or subtracted from the breakaway section 108 to allow the length of the breakaway section 108 to be customizable for the application and/or use of the breakaway attachment 100.

In some cases, the second breakaway section 124 further comprises a second breakaway section extension 136. In some cases, the second coupling end 126 is a different shape and/or material than the second breakaway section extension 136. In some cases, the second coupling end 126 is hollow while the second breakaway section extension 136 is solid. For example, the second coupling end 126 may be welded to the second breakaway section extension 136, attached using nuts and bolts, attached using screws, and/or any other acceptable method of securing the second coupling end 126 to the second breakaway section extension 136 known to those skilled in the art. In some cases, the second coupling end 126 and the second breakaway section extension 136 may be monolithic. In some cases, an additional breakaway section extension (not illustrated) can be added or subtracted from the second breakaway section 124 to allow the length of the second breakaway section 124 to be customizable for the application and/or use of the breakaway attachment 100.

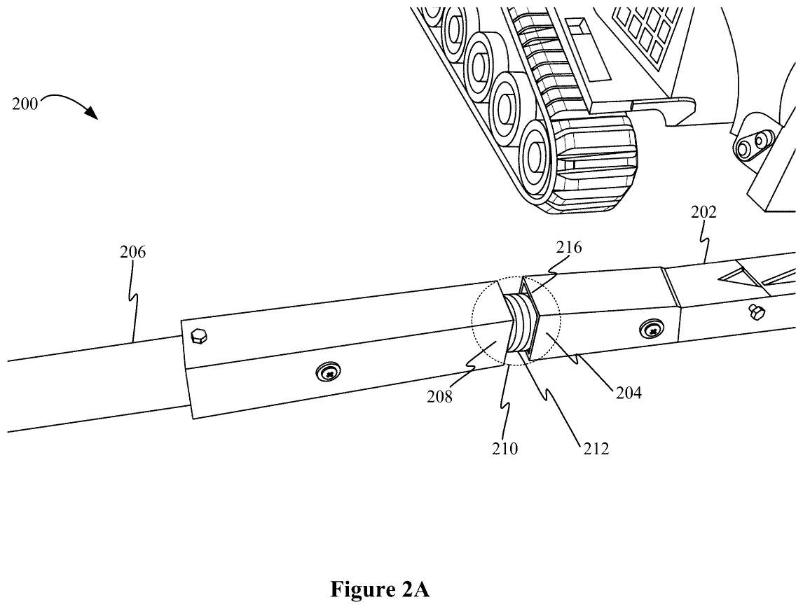

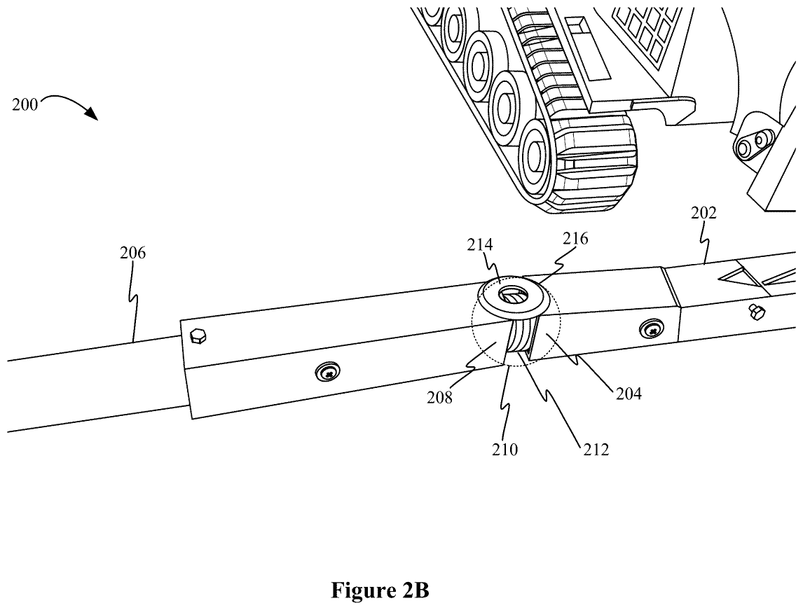

FIGS. 2A and 2B illustrate views of a breakaway joint. Referring to FIGS. 2A and 2B, a breakaway attachment 200 includes a stationary section 202 having a first stationary cnd 204, a breakaway section 206 having a coupling end 208, and a breakaway joint 210 including a spring 212 coupling to the first stationary end 204 of the stationary section 202 and the coupling end 208 of the breakaway section 206.

In some cases, referring to FIG. 2B, the coupling end 208 of the breakaway section 206 includes a covering 214 that extends over the spring 212 and proximally to the stationary section 202. In some cases, the first stationary end 204 includes an edge 216 that is proximal to the covering 214. In some cases, the edge 216 is a corresponding edge that is shaped to fit the covering 214 of the coupling end 208 of the breakaway section 206. In some cases, the covering 214 is a circular covering. In some cases, the corresponding edge 216 is an arcuate edge that is proximal to the circular covering 214 of the coupling end 208 of the breakaway section 206. In some cases, the covering 214 and corresponding edge 216 are any shape that allows for movement of the breakaway section 206 in any direction.

In some cases, the first stationary end 204 of the stationary section 202 includes a covering that extends over the spring 212 and proximally to breakaway section 206 and the coupling end 208 includes a coupling edge that is proximal to the covering. In some cases, the coupling edge is a corresponding edge that is shaped to fit the covering of the first stationary end 204 of the stationary section 202. In some cases, the covering is a circular covering. In some cases, the coupling edge is an arcuate edge that is proximal to the circular covering of the first stationary end 204 of the stationary section 202. In some cases, the covering and corresponding edge are any shape that allows for movement of the breakaway section 206 in any direction.

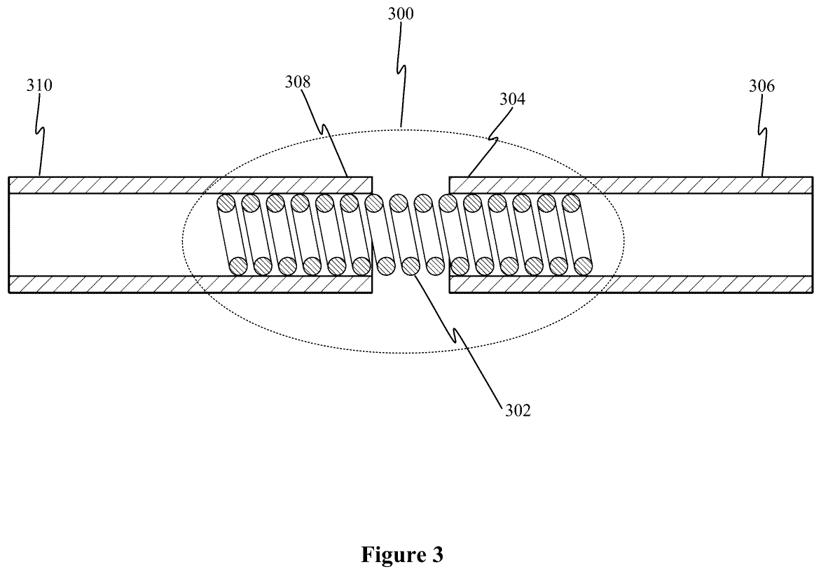

FIG. 3 illustrates a cross-sectional view of a breakaway joint. Referring to FIG. 3, the breakaway joint 300 includes a spring 302 coupling to the first stationary end 304 of the stationary section 306 and the coupling end 308 of the breakaway section 310. In some cases, the spring 302 is a heavy-duty expansion spring. In some cases, the spring 302 is an extension spring. In some cases, the spring 302 can be made of a metal, polymer, or any other acceptable material that allows for clastic deformation of the spring 302 in a forward, backward, upward, or downward direction. In some cases, the spring 302 can be a coil, or any other acceptable shape that allows for clastic deformation of the spring 302 in a forward, backward, upward, or downward direction. In some cases, the spring 302 can be made of a metal, polymer, or any other acceptable material that allows for clastic deformation of the spring 302 in any (e.g.,) 360° direction. In some cases, the spring 302 can be a coil, or any other acceptable shape that allows for clastic deformation of the spring 302 in any direction.

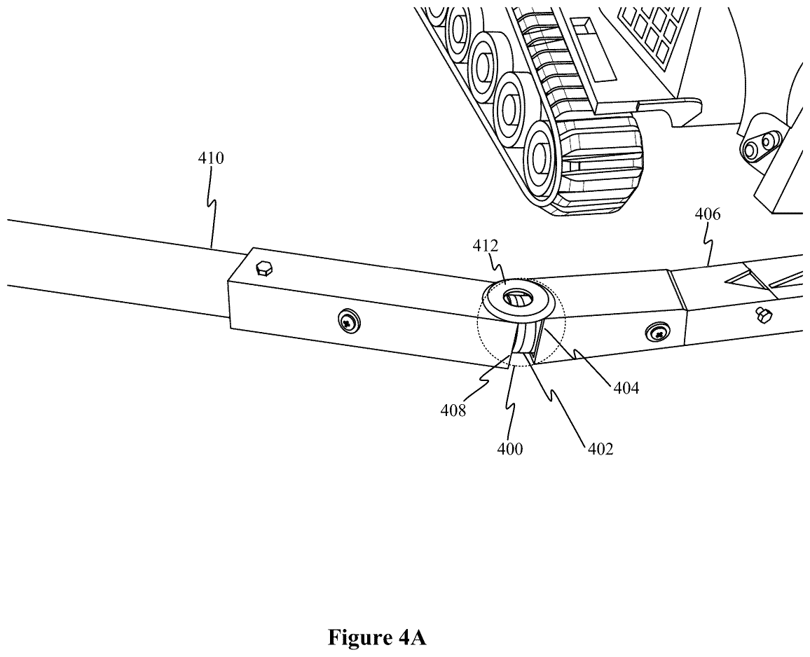

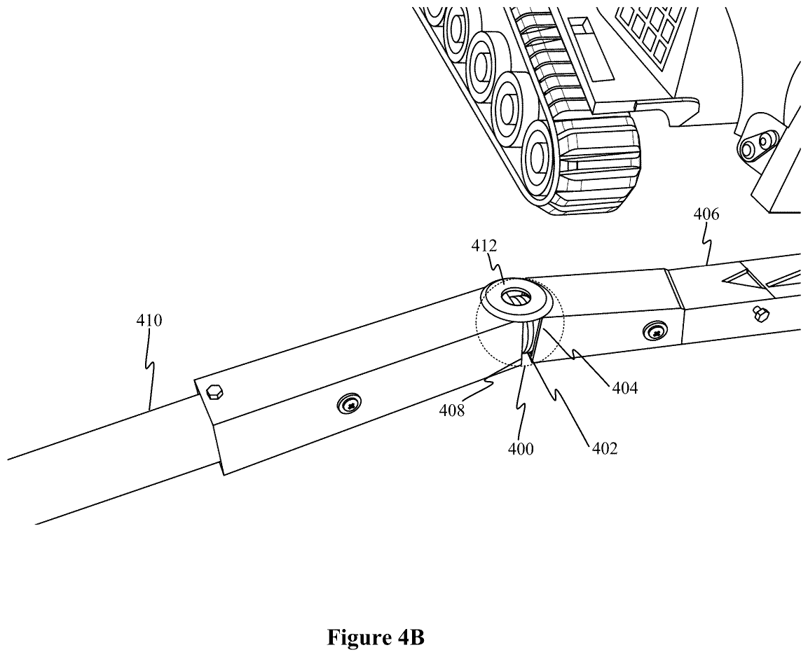

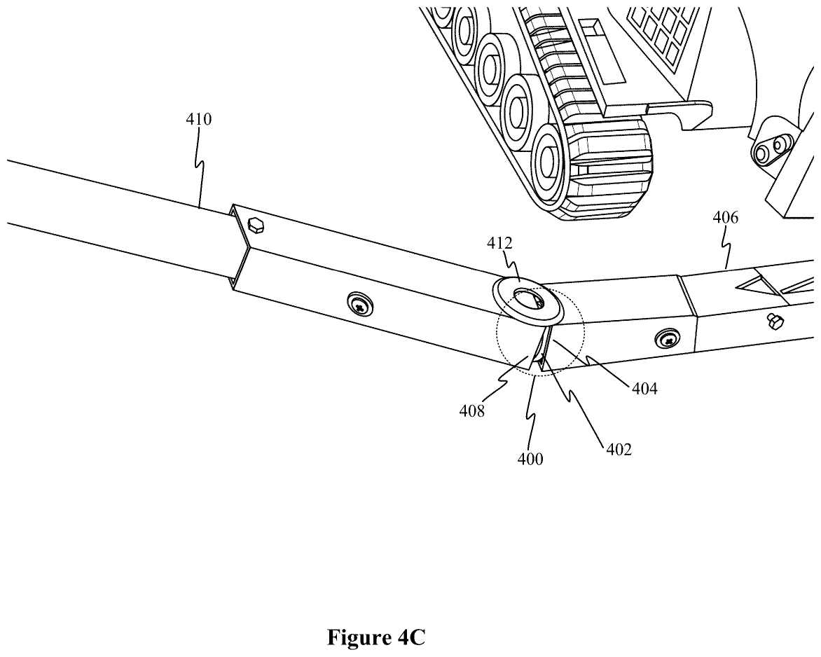

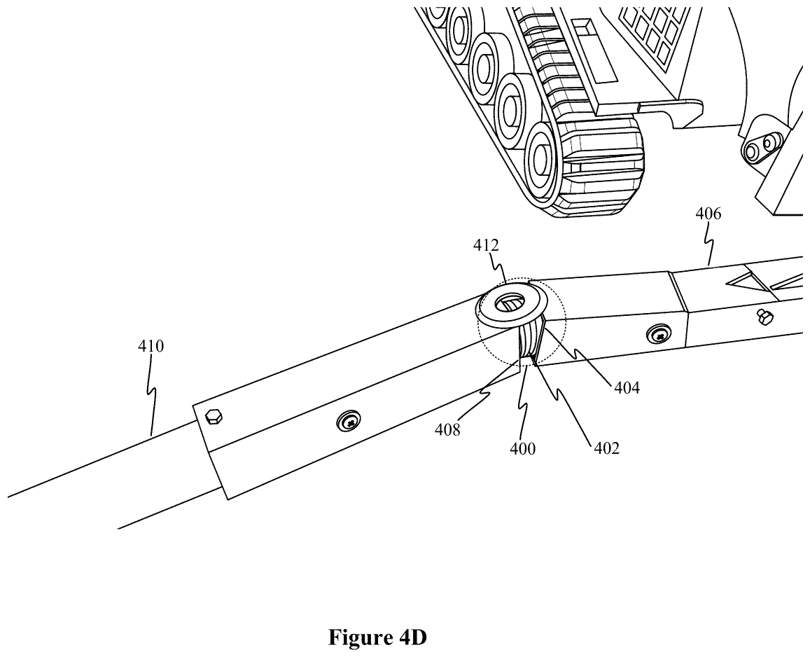

FIGS. 4A-4D illustrate different positions of a breakaway joint. Referring to FIGS. 4A-4D, the breakaway joint 400 includes a spring 402 coupling to the first stationary end 404 of the stationary section 406 and the coupling end 408 of the breakaway section 410. In some cases, the coupling end 408 of the breakaway section 410 includes a covering 412 that extends over the spring 402 and proximally to the stationary section 406.

The breakaway joint 400 allows the breakaway section 410 to move upward, downward, forward, and/or backward when the breakaway section 410 contacts an object or opposing force. In some cases, breakaway joint 400 allows the breakaway section 410 to move up to ninety degrees with respect to a longitudinal axis of the stationary section 406 in any direction (e.g.,) 360° when the breakaway section 410 contacts an object or opposing force. The spring 402 provides a force to the breakaway section 410 to return to an original position when the breakaway section 410 is no longer contacting the object or being moved by the opposing force.

FIG. 4A shows the breakaway section 410 in a backward position. FIG. 4B shows the breakaway section 410 in a forward position. FIG. 4C shows the breakaway section 410 in an upward position. FIG. 4D shows the breakaway section 410 in a downward position.

In some cases, the stationary section 406 further includes a second stationary end (e.g., 122 of FIG. 1), and the breakaway attachment (e.g., 100 of FIG. 1) further includes a second breakaway section (e.g., 124 of FIG. 1) having a second coupling end (e.g., 126 of FIG. 1) and a second breakaway joint (e.g., 128 of FIG. 1) including a second spring (e.g., 130 of FIG. 1) coupling to the second stationary end (e.g., 122 of FIG. 1) of the stationary section 406 and the second coupling end (e.g., 126 of FIG. 1) of the second breakaway section (e.g., 124 of FIG. 1).

The second breakaway joint (e.g., 128 of FIG. 1) allows the second breakaway section (e.g., 124 of FIG. 1) to move upward, downward, forward, and backward when the second breakaway section (e.g., 124 of FIG. 1) contacts an object or opposing force. In some cases, the second breakaway joint (e.g., 128 of FIG. 1) allows the second breakaway section (e.g., 124 of FIG. 1) to move up to ninety degrees upward, downward, forward, and backward with respect to the stationary section 406 when the second breakaway section (e.g., 124 of FIG. 1) contacts an object or opposing force. The second spring (e.g., 130 of FIG. 1) provides a force to the second breakaway section (e.g., 124 of FIG. 1) to return to an original position when the second breakaway section (e.g., 124 of FIG. 1) is no longer contacting the object or being moved by the opposing force.

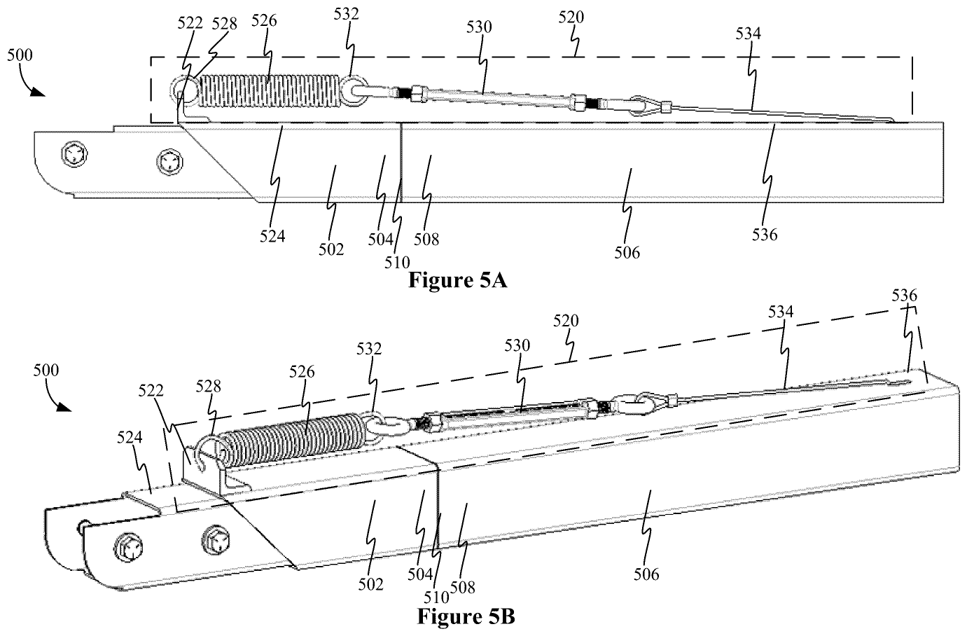

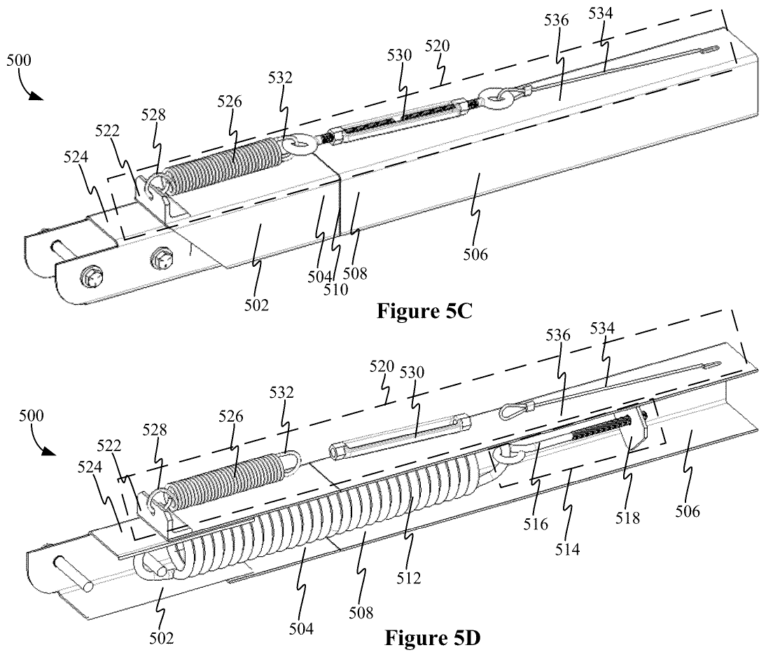

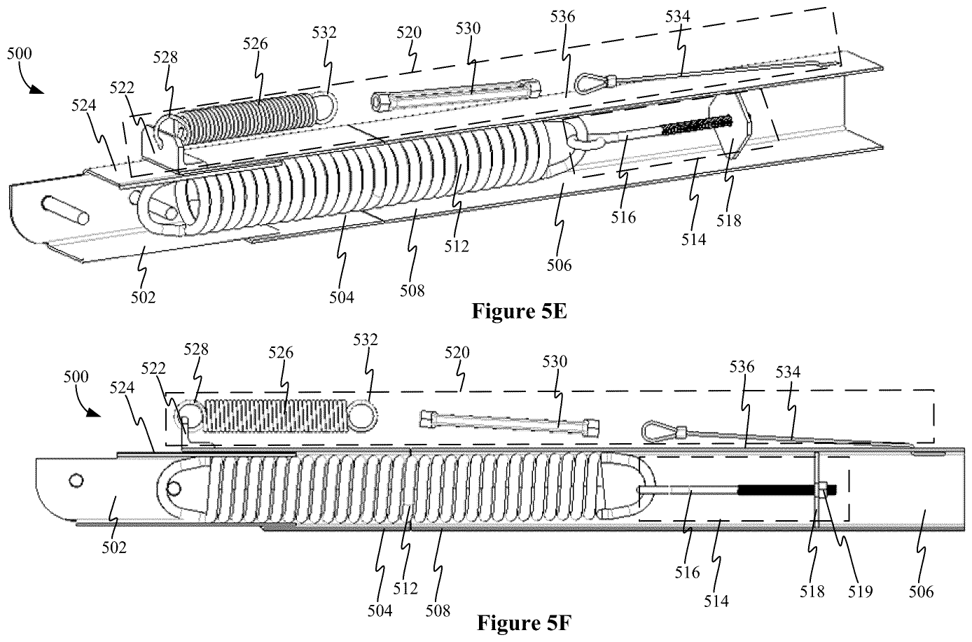

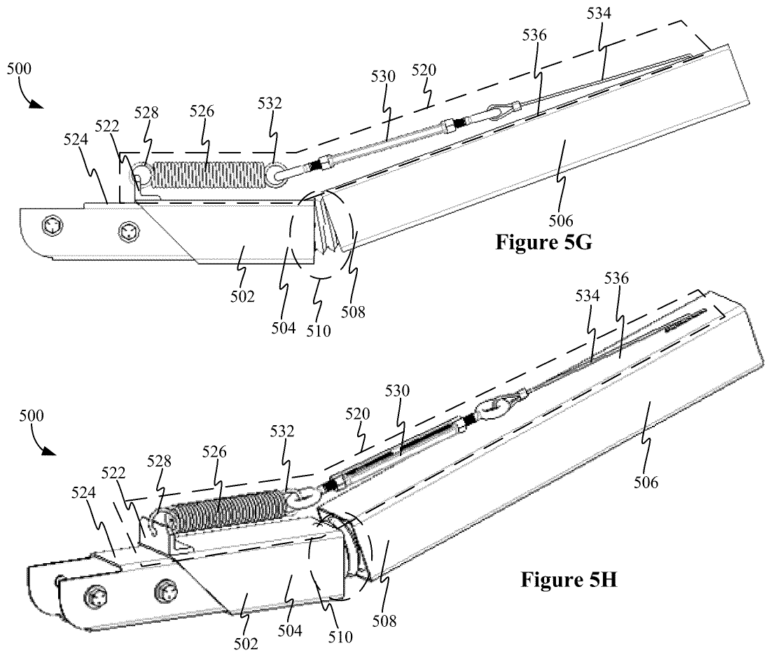

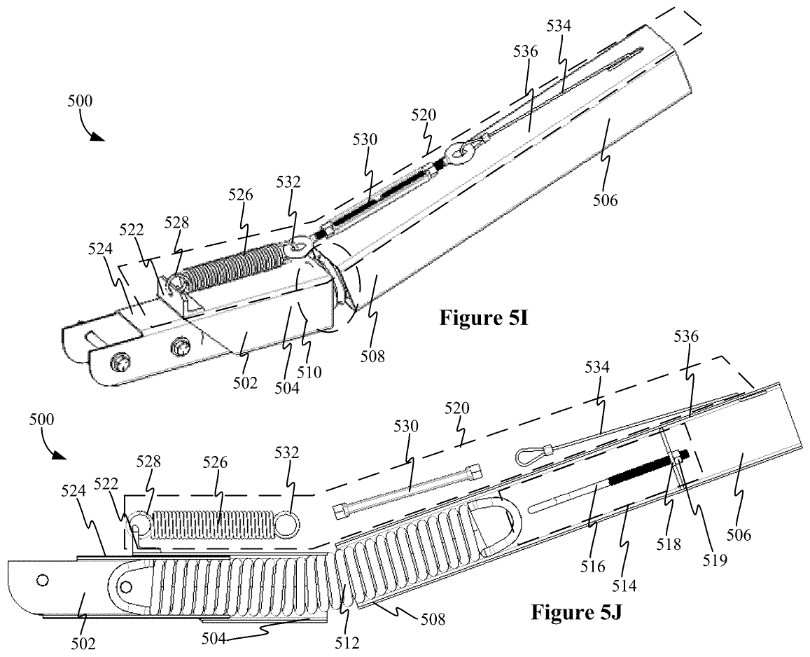

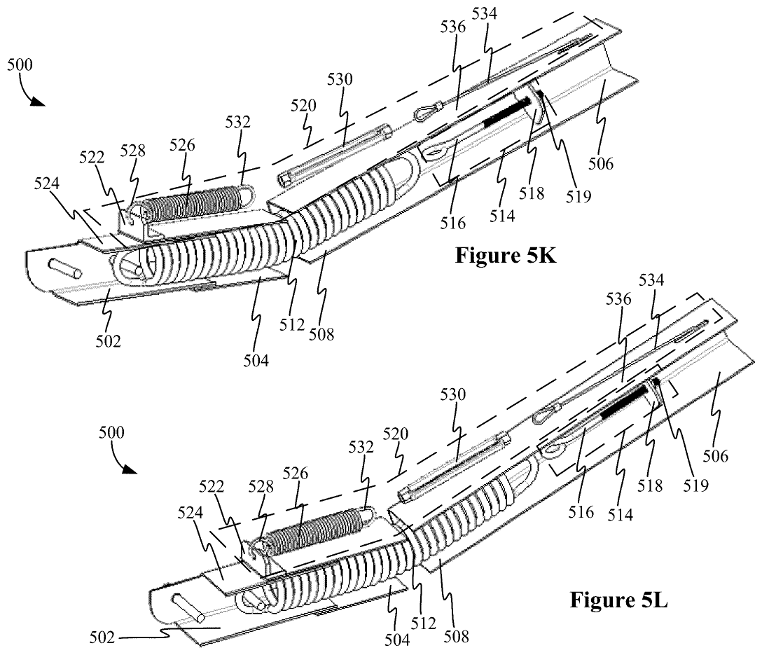

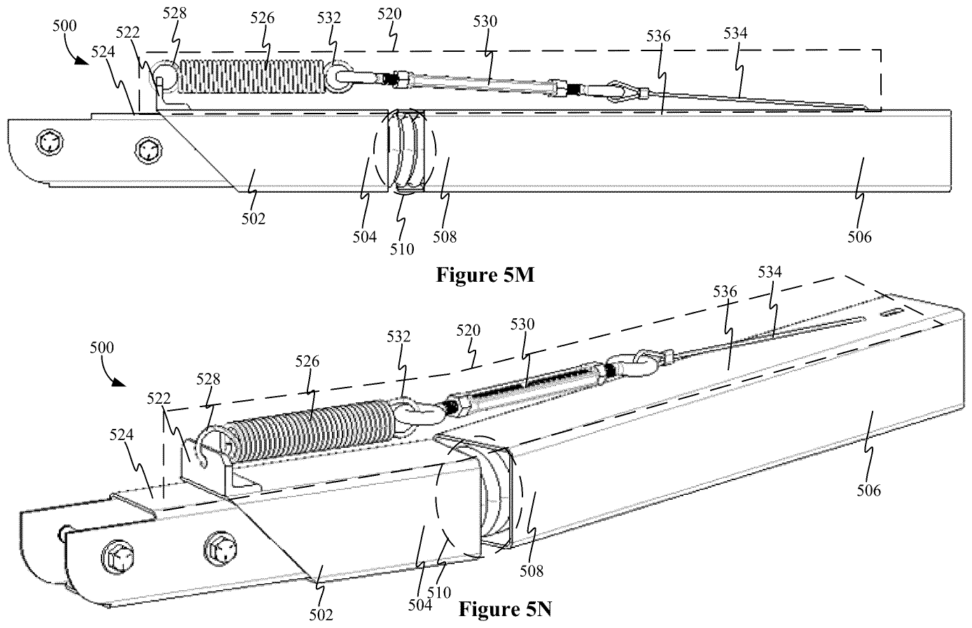

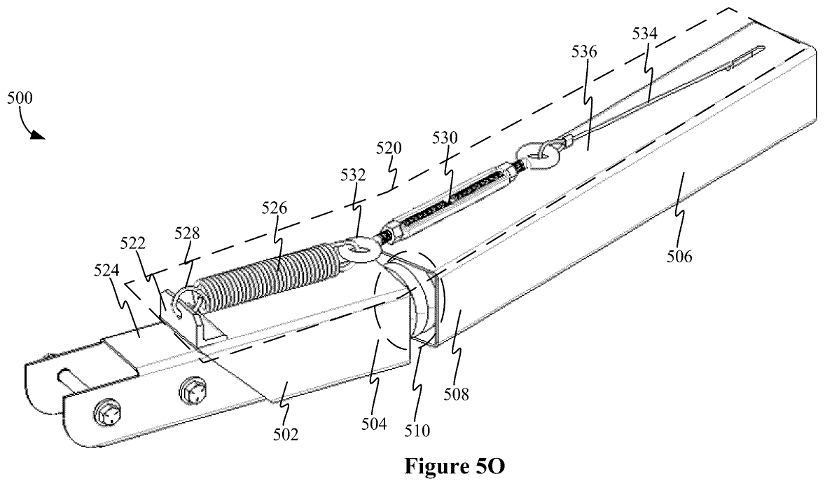

FIGS. 5A-5C illustrate views of a breakaway joint having deflection support. FIGS. 5D-5F illustrate cross-sectional views of a breakaway joint having deflection support. FIGS. 5G-5I illustrate views of a breakaway joint in an upward position having deflection support. FIGS. 5J-5L illustrate cross-sectional views of a breakaway joint in an upward position having deflection support. FIGS. 5M-5O illustrate views of a breakaway joint in a backward position having deflection support.

Referring to FIGS. 5A-5O, a breakaway attachment 500 for heavy equipment includes a stationary section 502 having a first stationary end 504, a breakaway section 506 having a coupling end 508, and a breakaway joint 510 including a spring 512 coupling to the first stationary end 504 of the stationary section 502 and the coupling end 508 of the breakaway section 506.

The breakaway attachment 500 further includes a spring tensioner device 514 coupled to the spring 512 of the breakaway joint 510 that allows the spring 512 to be tensioned to the desired level so that the spring 512 provides the desired force to the breakaway section 506 to return to an original position, such as illustrated in FIGS. 5A-5F, when the breakaway section 506 is no longer contacting the object or being moved by the opposing force. The spring tensioner device 514 can include an eye bolt 516 attached to the spring 512 and a tensioner bracket 518 attached to the coupling end 508 of the breakaway section 506. In some cases, a portion of the eye bolt 516 is threaded through the tensioner bracket 518 and a nut 519 is threaded on the portion of the eye bolt 516 that is threaded through the tensioner bracket 518 to keep the spring 512 tensioned to the desired level.

The breakaway attachment 500 further includes a deflection device 520 that prevents sagging and/or deflection of the breakaway section 506 due to the weight and/or load of the breakaway section 506 on the spring 512 of the breakaway joint 510. The deflection device 520 also prevents sagging and/or deflection of the breakaway section 506 due to metal fatigue on the spring 512 over a lifetime of use, and prevents the spring 512 from twisting and/or not returning to the original position after contact by an outside force. The deflection device 520 includes a deflection fixture 522 attached to a top portion 524 of the stationary section 502, a deflection spring 526 attached to the deflection fixture 522 at a first end 528 of the deflection spring 526, a turnbuckle 530 attached to a second end 532 of the deflection spring 526, and a metal cable 534 attached to the turnbuckle 530. The metal cable 534 can be attached directly to a top portion 536 of the breakaway section 506, for example, via welding, or can be attached to a second deflection fixture attached to the breakaway section 506.

In some cases, the deflection fixture 522 is attached to the top portion 524 of the stationary section 502 by welding the deflection fixture 522 to the top portion 524 of the stationary section 502. In some cases, the deflection fixture 522 is an angle. In some cases, the deflection fixture 522 is a washer. In some cases, the deflection fixture 522 is an inverse universal joint. In some cases, the deflection spring 526 is attached directly to the top portion 524 of the stationary section 502 with no deflection fixture 522.

The turnbuckle 530 allows for tightening and/or loosening of the deflection device 520 so that the breakaway attachment 500 can return to the original position, such as illustrated in FIGS. 5A-5F, when not being acted upon by an outside force, even if sagging and/or deflection of the breakaway section 506 due to the weight and/or load of the breakaway section 506 on the spring 512 of the breakaway joint 510 and/or metal fatigue of the spring 512 would occur without the deflection device 520. For example, the “tighter” the deflection device 520 is, the faster the breakaway section 506 will return to the original position. For example, the “looser” the deflection device 520 is, the slower the breakaway section 506 will return to the original position.

In some cases, the deflection spring 526 is a helical extension spring. The deflection spring 526 allows for 360° movement of the breakaway attachment 500. For example, the deflection spring 526 allows the breakaway attachment 500 in a forward, backward, upward, and/or downward direction.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

What is claimed is:

1. A breakaway attachment for heavy equipment, comprising:
a stationary section having a first stationary end;
a breakaway section having a coupling end; and
a breakaway joint comprising a spring coupling to the first stationary end of the stationary section and the coupling end of the breakaway section.

2. The breakaway attachment of claim 1, wherein the coupling end of the breakaway section comprises a covering that extends over the spring and proximally to the stationary section.

3. The breakaway attachment of claim 2, wherein the first stationary end comprises a corresponding edge that is shaped to fit the covering of the coupling end of the breakaway section.

4. The breakaway attachment of claim 1, further comprising a means for attaching the breakaway attachment to a piece of heavy equipment.

5. The breakaway attachment of claim 1, wherein the stationary section and the breakaway section are hollow.

6. The breakaway attachment of claim 1, further comprising a spring tensioner device coupled to the spring of the breakaway joint.

7. The breakaway attachment of claim 1, further comprising a deflection device coupled to the stationary section and the breakaway section.

8. The breakaway attachment of claim 7, wherein the deflection device comprises:
a deflection spring coupled to the stationary section;
a turnbuckle coupled to the deflection spring; and
a cable coupled to the turnbuckle.

9. The breakaway attachment of claim 1, wherein the breakaway joint allows the breakaway section to move in any direction when the breakaway section contacts an object.

10. The breakaway attachment of claim 9, wherein the wherein the spring provides a force to the breakaway section to return to an original position when the breakaway section is no longer contacting the object.

11. The breakaway attachment of claim 9, wherein the breakaway joint allows the breakaway section to move up to up to ninety degrees with respect to a longitudinal axis of the stationary section in any direction when the breakaway section contacts the object.

12. The breakaway attachment of claim 1, wherein the spring is a heavy-duty expansion spring.

13. The breakaway attachment of claim 1, wherein the stationary section further comprises a second stationary end, the breakaway attachment further comprising:
a second breakaway section having a second coupling end; and
a second breakaway joint comprising a second spring coupling to the second stationary end of the stationary section and the second coupling end of the second breakaway section.

14. The breakaway attachment of claim 1, further comprising:
a fluid conveyance device coupled to the stationary section and the breakaway section for conveying a fluid; and
a fluid applicator coupled to the stationary section and the breakaway section and fluidically coupled to the fluid conveyance device for applying the fluid to a surface.

15. A breakaway attachment for heavy equipment, comprising:
a stationary section having a first stationary end and a second stationary end;
a first breakaway section having a first coupling end;
a first breakaway joint comprising a first spring coupling to the first stationary end of the stationary section and the coupling end of the breakaway section;
a second breakaway section having a second coupling end; and
a second breakaway joint comprising a second spring coupling to the second stationary end of the stationary section and the second coupling end of the second breakaway section.

16. The breakaway attachment of claim 15, further comprising a means for attaching the breakaway attachment to a piece of heavy equipment.

17. The breakaway attachment of claim 15, further comprising:
a fluid conveyance device coupled to the stationary section, the first breakaway section, and the second breakaway section for conveying a fluid; and
a fluid applicator coupled to the stationary section, the first breakaway section, and the second breakaway section, and fluidically coupled to the fluid conveyance device for applying the fluid to a surface.

18. The breakaway attachment of claim 15, wherein:
the first breakaway joint allows the first breakaway section to move in any direction when the first breakaway section contacts a first object; and
the second breakaway joint allows the second breakaway section to move in any direction when the second breakaway section contacts a second object.

19. The breakaway attachment of claim 18, wherein:
the first spring provides a force to the first breakaway section to return to a first breakaway section original position when the first breakaway section is no longer contacting the first object; and
the second spring provides a force to the second breakaway section to return to a second breakaway section original position when the second breakaway section is no longer contacting the second object.

20. The breakaway attachment of claim 18, wherein:
the first breakaway joint allows the first breakaway section to move up to ninety degrees with respect to a longitudinal axis of the stationary section in any direction when the first breakaway section contacts the first object; and
the second breakaway joint allows the second breakaway section to move up to ninety degrees with respect to a longitudinal axis of the stationary section in any direction when the second breakaway section contacts the second object.
